(19) United States
(12) Patent Application Publication
(10) Pub. No.: US 2025/0336108 A1
(43) Pub. Date: Oct. 30, 2025

(54) METHOD FOR DISPLAYING A THERMAL IMAGE

(71) Applicant: Testo SE & Co. KGaA, Titisee-Neustadt (DE)

(72) Inventors: Philipp SASSE, Titisee (DE); Stefanie ARNOLD, Wurmlingen (DE); Sabine de ROSSO, Löffingen-Bachheim (DE); Jan-Friso EVERS-SENNE, Titisee-Neustadt (DE)

(73) Assignee: Testo SE & Co. KGaA, Titisee-Neustadt (DE)

(21) Appl. No.: 19/192,493

(22) Filed: Apr. 29, 2025

(30) Foreign Application Priority Data
Apr. 29, 2024 (EP) 24172975.5

(51) Int. Cl. G06T 11/00; G06T 5/40; G06T 5/94; G06T 7/11

(52) U.S. Cl. CPC G06T 11/001; G06T 5/40; G06T 5/94; G06T 7/11; G06T 2200/24; G06T 2207/20104

(57) ABSTRACT

A method for displaying a thermal image is provided, in which one color of a color palette is assigned in each case to one temperature range of the thermal image. The colors are assigned to the temperature ranges depending on whether certain criteria of the temperature distribution occur in a geometric region of the thermal image.

### CROSS-REFERENCE TO RELATED APPLICATIONS

This application claims priority from European Patent Application No. 24172975.5, filed Apr. 29, 2024, which is incorporated herein by reference as if fully set forth.

### TECHNICAL FIELD

The invention relates to a method for displaying a thermal image, wherein a color of a color palette is assigned to each temperature range of the thermal image.

### BACKGROUND

Thermal imaging cameras have become sufficiently known over time in the prior art. A thermal imaging sensor which is sensitive in the infrared range is used here. In general, a false color display is created from the sensor values of the thermal imaging sensor to display a thermal image.

A limited number of colors are usually available for this purpose, which are assigned to individual temperature values or temperature ranges. The color palette can be permanently specified within the measuring range of the thermal imaging sensor. This means that a color is permanently assigned to a temperature, independently of the temperature distribution in the overall image. There is the problem here that under certain circumstances a very low contrast results in the image if only a small temperature range of the overall measuring range is present.

To increase the contrast in such cases, dynamically adapting the color palette to the temperature range which is actually present in the thermal image is known, for example, wherein the color assignment still takes place linearly. This means that the colors available are no longer distributed onto the overall measuring range, but rather onto the temperature range present.

Furthermore, performing a so-called histogram equalization is known, in which frequently occurring temperature values are weighted more strongly and therefore their contrast is increased.

However, the contrast can be amplified in this case for less relevant image contents depending on the scene, while a low contrast results in the image for the regions actually of interest.

### SUMMARY

The object of the invention is therefore to provide a method of the type mentioned at the outset which permits an improved display of a thermal image.

This object is achieved by a method having one or more of the features disclosed herein.

According to the invention, the colors are accordingly assigned to the temperature ranges depending on whether certain criteria of the temperature distribution occur in a geometric region of the thermal image.

The display of the overall image is adapted here so that the contrast is optimized or improved in the geometric region. In this way, it is possible to display a geometric region particularly clearly independently of the temperature distribution in the overall image.

In one embodiment, more colors of the color palette are assigned to a temperature range which occurs within a region of interest in the thermal image than would be the case with uniform color distribution. A nonlinear assignment of colors results in this way, which represents the temperature range within the region of interest with better contrast and higher color resolution in relation to the remainder of the thermal image. The display of the thermal image is thus significantly improved.

In one embodiment, a greater range of the color palette is assigned to a temperature range the more frequently and the geometrically closer to a region of interest of the thermal image temperature values occur within the temperature range.

In other words, a number of colors is assigned to a temperature range depending on how much more frequently and how much geometrically closer to a region of interest of the thermal image temperature values occur within the temperature range.

The display of the region of interest is thus selectively improved, while the remainder of the thermal image nonetheless remains recognizable.

In one embodiment, temperature ranges having specific gradients within a region of interest have a larger range of the color palette assigned.

According to one embodiment, at least one region of interest is marked in the thermal image. An imaging function, according to which the colors are assigned to a temperature range, is thereupon defined, wherein contrasts in the region of interest are amplified and contrasts outside the region of interest are reduced. The region of interest is a geometric region within the thermal image.

The invention considers, among other things, the case that the region of interest does not contain all temperature values of the overall thermal image. This means that the region of interest also corresponds to a temperature range which is a real subset of the temperature range of the overall thermal image. In exceptional cases, it can occur that this does not apply. In these exceptional cases, the effect according to the invention does not result. However, these exceptional cases are not the target of the invention and are to remain unconsidered in this case.

The invention is also applicable in the case when the region of interest comprises the full temperature range (but with different distribution).

The term region of interest therefore hereinafter is meant both as a geometric region and also a temperature range.

An improved display is achievable for this geometric region by the adaptation of the imaging function to the selected region of interest.

In one embodiment, to improve the contrast, the imaging function is divided into various sections, wherein a first section is given by the temperature limits of the at least one region of interest, and further sections image the temperatures outside the at least one region of interest, wherein the imaging function is selected in the first section so that contrasts are increased, and wherein the imaging function is selected in the further sections so that contrasts are reduced.

In one embodiment, the imaging function assigns more colors to the first section than to the further sections to increase the contrast.

Alternatively and/or additionally, in one embodiment the imaging function is selected according to a histogram equalization, wherein the temperature values within the first section are weighted more strongly than temperature values which only occur in further sections.

In one embodiment, a temperature value which occurs within the region of interest is multiplied by a weighting factor in the creation of the histogram, so that the temperature value is taken into consideration disproportionately in the histogram.

In one embodiment, the region of interest is marked by selecting a pixel or image detail. The region of interest can also comprise multiple pixels of the thermal image here, wherein, for example, the region of interest is defined by a rectangle or a circle around the selected pixel. The size of the rectangle or the circle can be specified, settable, or selectable here.

In one embodiment, the region of interest is marked in an automated manner in the image center of the thermal image or at a point having the highest or lowest temperature. In this way, easy marking of the region of interest is possible by changing the image detail. A thermal imaging camera can also comprise, for example, means for representing the region of interest on the object to be measured. This can be a laser projector, for example.

In one embodiment, a size of the region of interest is defined, settable, and/or changeable. The region of interest can be changed depending on the measuring situation in this way.

In one embodiment, the region of interest is defined by a circle, a rectangle, a square, or another geometry.

In one embodiment, an image is provided in the visible spectral range, the image detail of which substantially corresponds to the image detail of the thermal image. The region of interest is marked in this visible image and the region of interest is transferred to the thermal image. In this way, a region of interest can be marked and possibly changed in its size and/or shape in a simple manner.

In one embodiment, multiple regions of interest can be marked, which are viewed as one contiguous region of interest in the context of the method. Accordingly, multiple geometric regions, which are also noncontiguous, define a temperature range of interest.

### BRIEF DESCRIPTION OF THE DRAWINGS

The invention is explained in more detail hereinafter with reference to the appended drawings.

In the figures:

FIG. 1: shows a thermal image of a first scene having a region of interest indicated, which is approximately in the image center,

FIG. 2: shows an enlarged view of the region of interest of the thermal image of FIG. 1,

FIG. 3: shows the histogram of the thermal image of FIG. 1,

FIG. 4: shows a diagram of a linear imaging function of the temperature values for an integer value which can be assigned to a color,

FIG. 5: shows a diagram of a sectionally linear imaging function of the temperature values,

FIG. 6: shows the thermal image of FIG. 1 with colors selected according to the sectional imaging function of FIG. 5,

FIG. 7: shows the histogram of the thermal image of FIG. 6,

FIG. 8: shows a histogram of the thermal image of FIG. 1, in which the region of interest is weighted tenfold,

FIG. 9: shows the thermal image of FIG. 1 with a conventional histogram equalization,

FIG. 10: shows the thermal image of FIG. 1 with a histogram equalization according to the tenfold weighted histogram of FIG. 8,

FIG. 11: shows the histogram of the thermal image of FIG. 9,

FIG. 12: shows the histogram of the thermal image of FIG. 10,

FIG. 13: shows a thermal image of a second scene having an indicated region of interest which is in the bottom left image corner,

FIG. 14: shows the histogram of the thermal image of FIG. 13,

FIG. 15: shows a diagram of a linear imaging function of the temperature values for an integer value which can be assigned to a color,

FIG. 16: shows a diagram of a sectionally linear imaging function of the temperature values,

FIG. 17: shows the thermal image of FIG. 13 with colors selected according to the sectional imaging function of FIG. 16,

FIG. 18: shows the histogram of the thermal image of FIG. 17,

FIG. 19: shows a histogram of the thermal image of FIG. 13, in which the region of interest is weighted tenfold,

FIG. 20: shows the thermal image of FIG. 13 with a conventional histogram equalization,

FIG. 21: shows the thermal image of FIG. 13 with a histogram equalization according to the tenfold weighted histogram of FIG. 19,

FIG. 22: shows the histogram of the thermal image of FIG. 20,

FIG. 23: shows the histogram of the thermal image of FIG. 21,

FIG. 24: shows a flow chart of a method for coloring a thermal image,

FIG. 25: shows a flow chart of a first method for creating an imaging function, and

FIG. 26: shows a flow chart of a second method for creating an imaging function.

### DETAILED DESCRIPTION

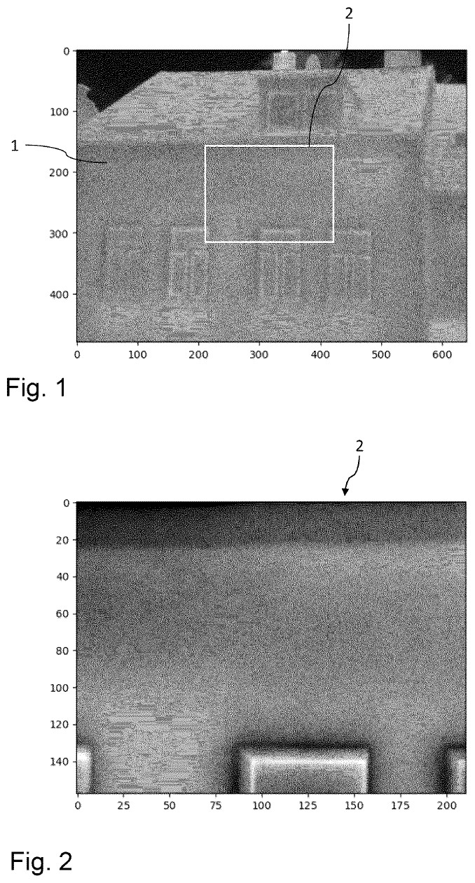

FIG. 1 shows a thermal image 1 of a first scene having an indicated region of interest 2, which is approximately in the image center. FIG. 2 shows the detail of the region of interest 2 in an enlarged view.

In the example, the global temperature minimum (Gmin) in the scene is 4.4° C. and the global temperature maximum (Gmax) is 21.2° C. Within the region of interest (Rol), the regional minimum (Rmin) is 10.2° C. and the regional maximum (Rmax) is 13.6° C.

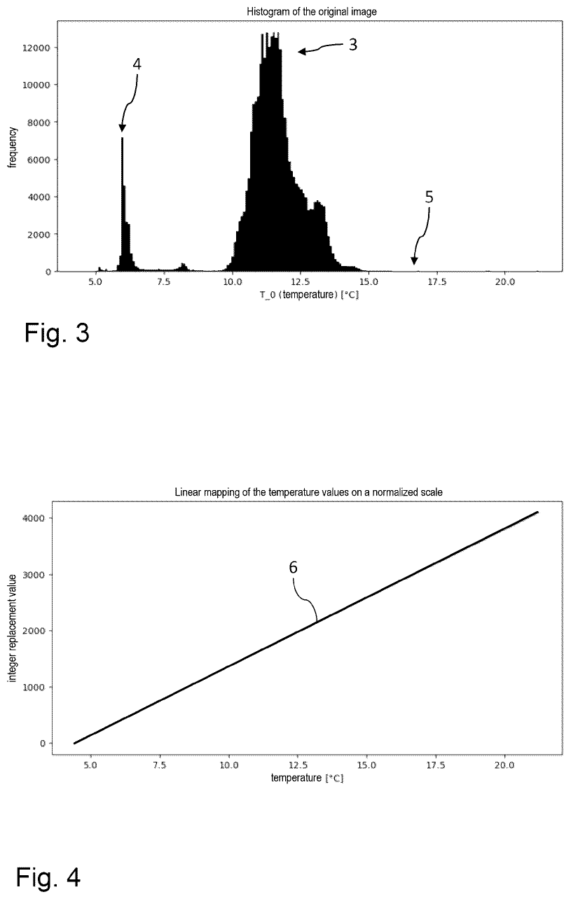

FIG. 3 shows the histogram of this thermal image. The histogram has a main peak 3 between 10° C. and 13° C., which is formed by the house wall, for example. Accordingly, the region of interest is essentially located within this main peak 3.

A second peak 4 is at approximately 6° C., which is probably formed by the sky.

A flat region 5 above 15° C. reflects the sum of all small heat sources.

FIG. 4 shows a linear imaging function 6, on the basis of which the thermal image of FIG. 1 is colored and displayed. Such linear imaging functions are typical in the prior art.

In the example, the color palette has 4096 colors. The imaging function 6 transforms the temperature values (X axis) of the thermal imaging sensor to an integer number (Y axis) in the range between 0 and 4095. The color palette is in turn a so-called lookup table, which assigns a color value to each value between 0 and 4095.

The imaging function 6 of FIG. 4 is scaled to the temperature range actually present in the scene. In the example, the temperature minimum Gmin in the scene is 4.4° C. and the temperature maximum Gmax is 21.2° C. The imaging function 6 of FIG. 4 is selected so that it linearly assigns the temperature range between Gmin and Gmax to the existing 4096 color values. In this way, the entire color palette is used in the image.

In general, the imaging function can be described as follows:

$$[ Gmin , Gmax ] -> [ 0 , resolution ]$$

$$resolution = 4096$$

$$s = resolution / ( Gmax - Gmin ) \# scale factor$$

$$imgNorm = ( imgRad - Gmin ) * s$$

Gmin is the global minimum of the temperature values in the thermal image.

Gmax is the global maximum of the temperature values in the thermal image.

In the example, Gmin=4.4° C. and Gmax=21.2° C. would apply.

However, as is apparent on the basis of the histogram, a large part of the color palette is used for ranges not of interest, while the temperature range of interest only uses approximately 17% of the existing colors.

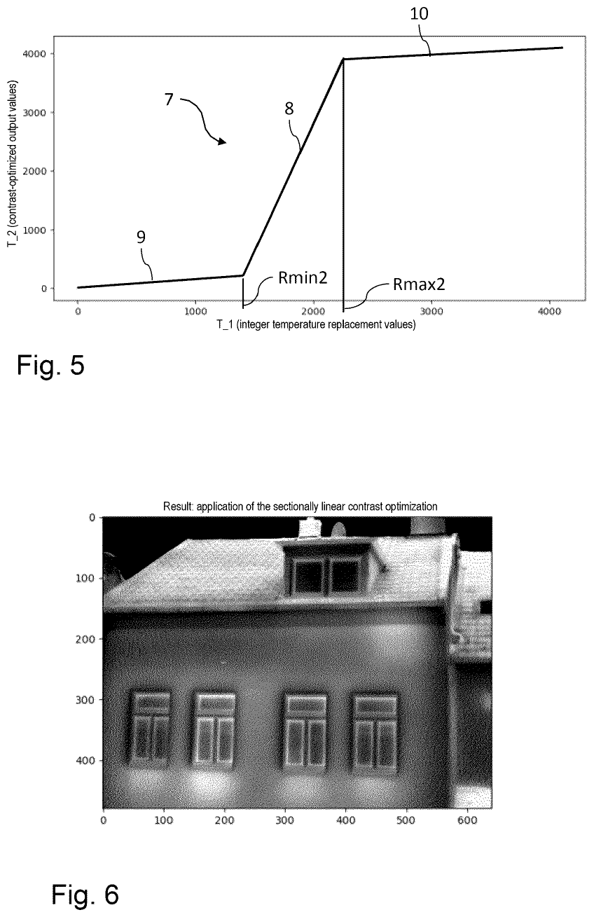

According to one embodiment of the invention, this linear imaging function is changed into a sectionally linear imaging function. Such a sectionally linear imaging function 7 is shown as an example in FIG. 5.

The sectionally linear imaging function 7 essentially consists of three sections, wherein a first section 8 is defined by the regional temperature minimum Rmin and the regional temperature maximum Rmax. In addition, there are further sections below 9 and above 10 these regional extremes.

Most colors of the color palette are then used for the first section 8 in order to increase the contrast for this region of interest.

This imaging function 7 is designed in the example as a transfer function, which assigns a different integer color value to an integer color value. Accordingly, the X axis and the Y axis extend from 0 to 4095.

The imaging function 7 is selected so that 90% of the available colors of the color palette are used for the section 8 Rmin2<T_1<Rmax2 in the example. The lower section 9 and the upper section 10 each receive 5% of the colors. The region of interest 2 is thus displayed substantially more detailed and with higher contrast in comparison to the linear imaging function 6. Of course, the proportions of the individual sections can also be selected differently, such as 85% for the region of interest, 10% and 5% for the other regions. This can be selected differently depending on the application and also depending on the image.

However, the sectional linear imaging function 7 can also assign a color value (Y axis) to a temperature value (X axis) like the imaging function 6.

FIG. 6 shows the thermal image of FIG. 1, which is colored according to the sectionally linear imaging function 7 shown in FIG. 5. The display is substantially more detailed and higher contrast in comparison to FIG. 1 within the temperature range present in the region of interest 2.

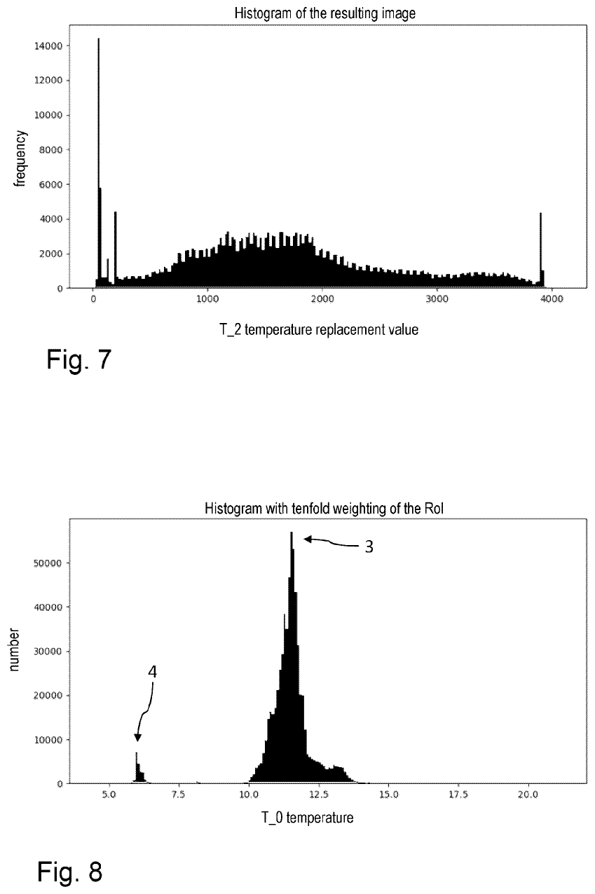

FIG. 7 shows the histogram of the thermal image colored using this imaging function 7 for confirmation purposes. The temperature range recognized as being of interest according to the region of interest 2 now utilizes the largest proportion of the dynamic range, namely 90%. In relation to FIG. 1, five times more colors are thus used in the region of interest 2, due to which the display is substantially improved. Structure can nonetheless still be seen in the adjoining temperature ranges. Clipping only takes place for the cold sky.

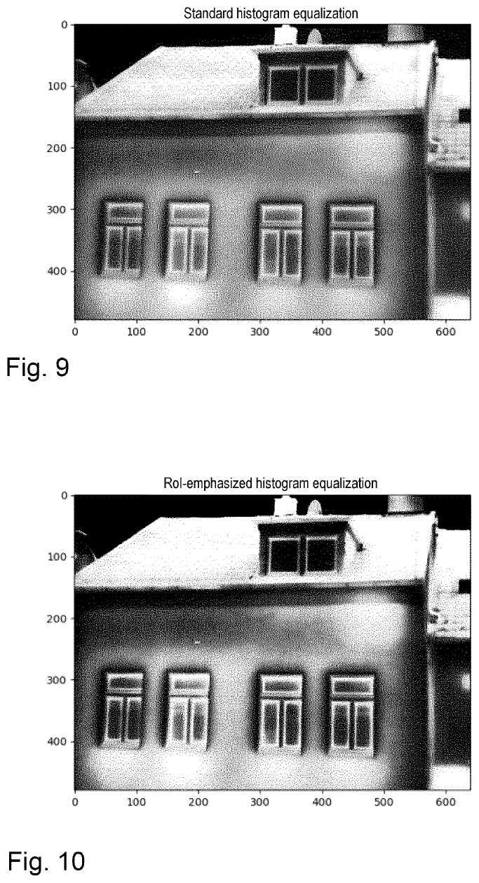

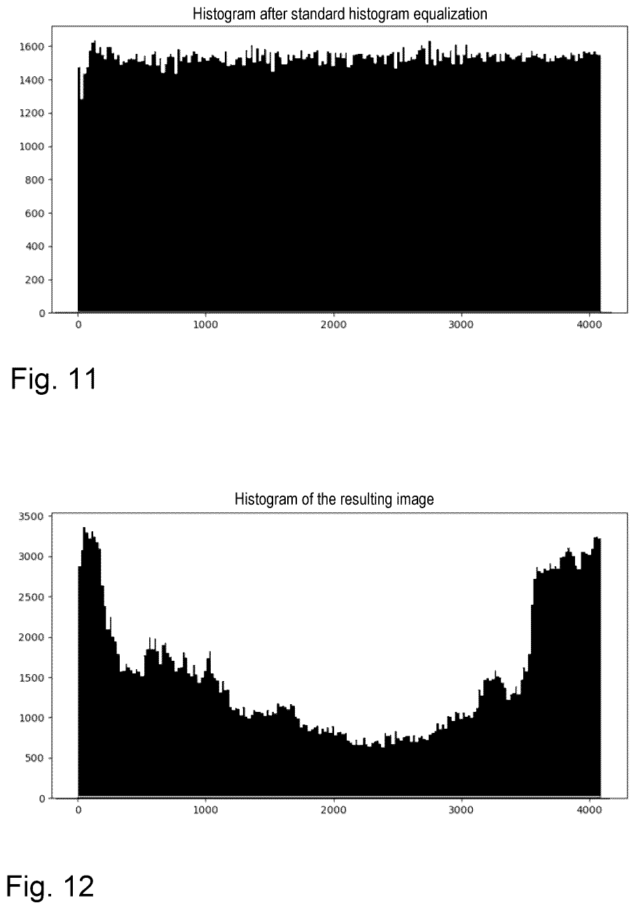

A so-called automatic histogram equalization for improving the display is also known in the prior art. The temperature values in the thermal image are essentially counted here and the colors are assigned in accordance with the frequency of the individual temperature values. FIG. 9 shows the thermal image of FIG. 1 after such an automatic histogram equalization. The associated histogram is shown in FIG. 11. The histogram typically more or less forms a straight line after an automatic histogram equalization. An improvement of the display is already possible in this way. However, in the example, the roof and the sky comprise approximately ⅓ of the pixels, so that these regions are also amplified by the automatic histogram equalization.

According to a further embodiment of the invention, instead a histogram equalization adapted to the region of interest is performed. For this purpose, initially the temperature values within the region of interest are weighted more strongly using a factor, thus multiplied, starting from the histogram of the starting image.

An imaging function essentially results here which assigns one color of the color palette to one temperature value.

FIG. 8 shows the histogram of FIG. 3 with a weighting factor of 10. It can be seen clearly in this case that above all the main peak 3, which is substantially within the region of interest 2, becomes taller and narrower. The second peak 4 is substantially damped in relation to FIG. 3.

A histogram equalization is now carried out starting from this weighted histogram. FIG. 10 shows the associated thermal image and FIG. 12 shows the histogram. This histogram, similarly to the histogram of the sectionally linear imaging function in FIG. 7, displays clear peaks at the two edges. This indicates that many pixels are located within these regions, which only use a few colors, however. The region of interest is in the middle and also uses more colors in total here.

In the direct comparison of the thermal images of FIGS. 10 and 12, the better contrast of FIG. 12 within the region of interest can be clearly seen.

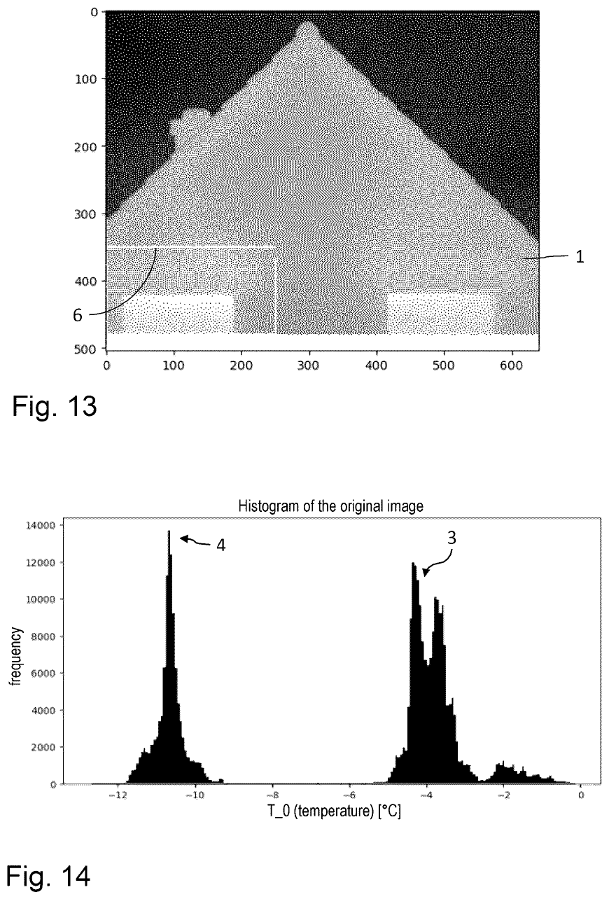

FIG. 13 shows a thermal image of a second scene having a region of interest 2, which is in the bottom left corner of the image here.

FIG. 14 shows the histogram of the thermal image of FIG. 13. This shows a main peak 3 around −4° C., which reflects the wall and is located within the region of interest, and a second peak 4 at approximately −10.5° C., which reflects the sky.

The exemplary scene has the following temperature values in the above-defined notation.

| | |
|---|---|
| Gmin = −12.8° C.; | Gmax = −0.1° C. |
| Rmin = −4.9° C.; | Rmax = −0.1° C. |

In this example, Rmax=Gmax thus applies.

According to the rule set forth above, in the definition of the sectionally linear imaging function 7, it results in this example that only two sections are present, a first section 8, corresponding to the region of interest 2, and a lower section 9. There is no upper section for which T_1>Rmax2 applies.

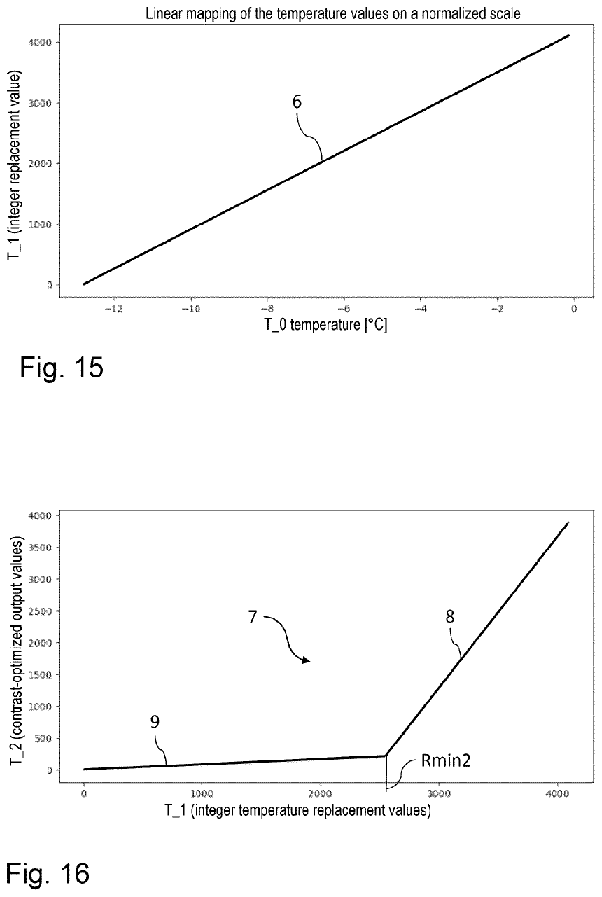

FIG. 15 shows, analogously to FIG. 4, the linear imaging function 6 of the thermal image of FIG. 13. FIG. 16 shows the sectionally linear imaging function 7. The sectionally linear imaging function 7 is also represented in simplified form here as a transfer function between integer color values, but could just as well assign one color value to one temperature value as an imaging function.

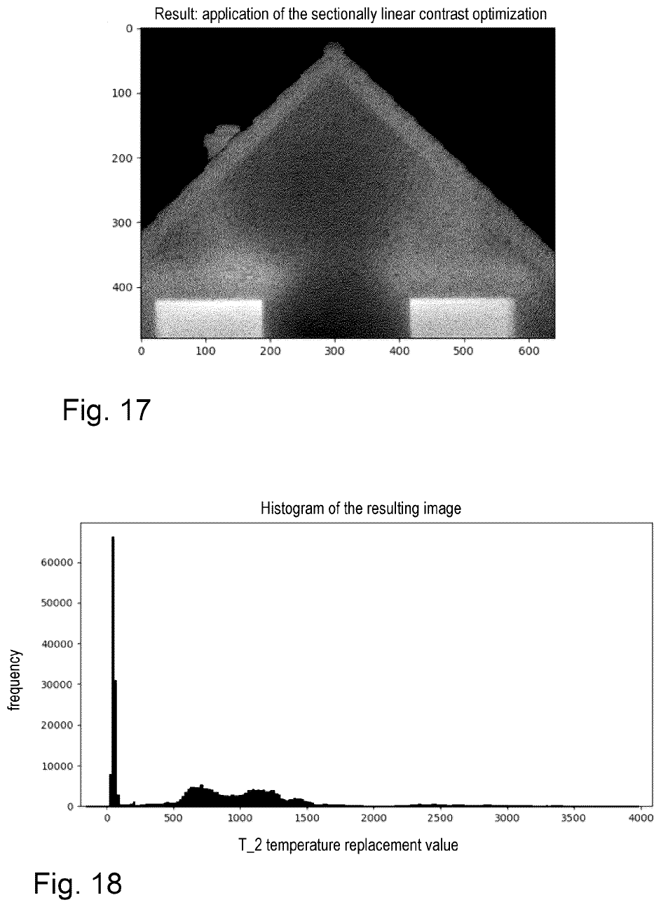

FIG. 17 shows the thermal image 1 of FIG. 13 colored according to the sectionally linear imaging function 7 of FIG. 16. The improved contrast of the house wall can be clearly seen in comparison to FIG. 13. The histogram 13 of the thermal image of FIG. 17 is shown in FIG. 18. This shows a peak which reflects the lower region 9. Few colors are thus used for many pixels, while the region of interest 2 uses the largest proportion of the colors.

Analogously to the first scene, an adapted histogram equalization can also alternatively be applied here.

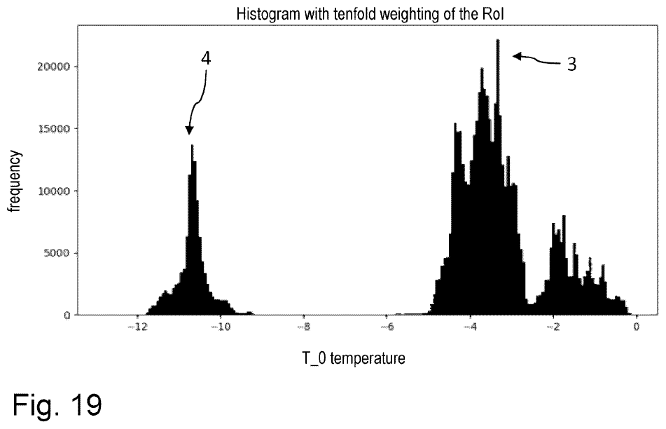

FIG. 19 shows the histogram, weighted by a weighting factor 10, of the histogram of the thermal image of FIG. 13 shown in FIG. 17. It can be seen clearly here that the resulting first peak 3 is narrower and lower in comparison to the second peak.

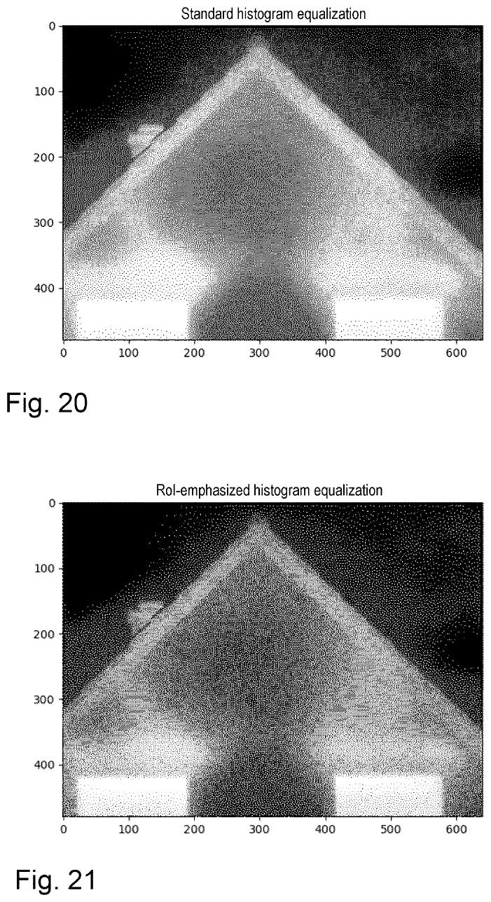

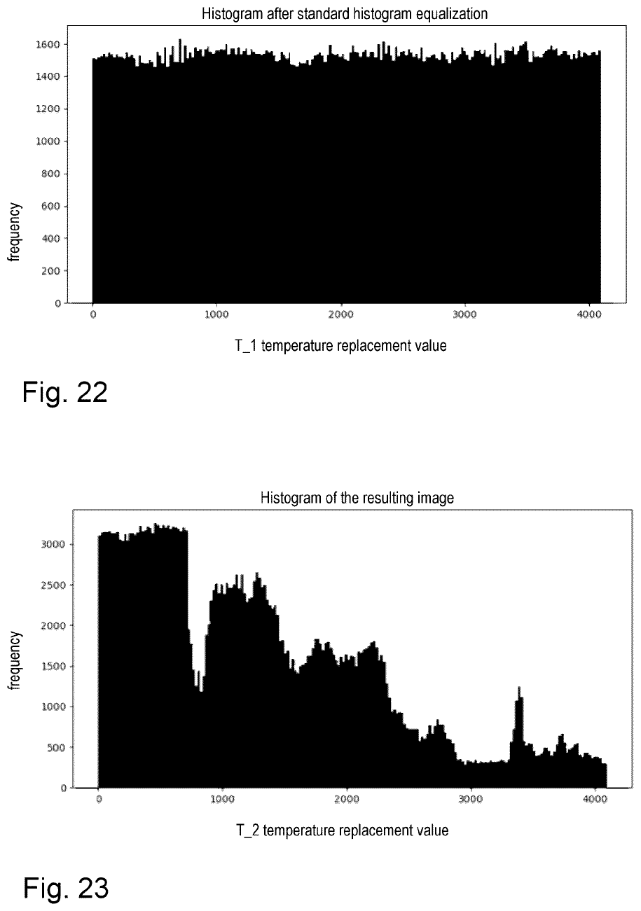

FIG. 20 shows the thermal image of FIG. 13 with a standard histogram equalization. The associated histogram is shown in FIG. 22. As expected, this histogram also forms a straight line or a plateau.

FIG. 21 shows the thermal image of FIG. 13 with an adapted histogram equalization according to the weighted histogram of FIG. 19. As can be seen in the associated histogram in FIG. 23, the region of interest is distributed here onto a broader color range. The thermal image thus receives a greater contrast in the region of interest.

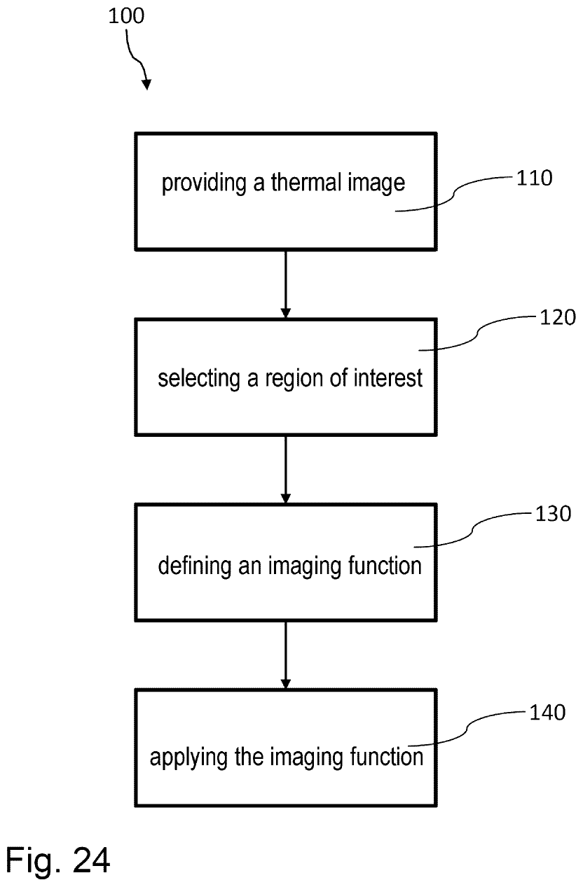

FIG. 24 shows a flow chart of a method 100 according to the invention for displaying a thermal image.

In a first step 110, initially a thermal image is provided, for example, by a thermal imaging camera. This thermal image can comprise, for example, raw data of a thermal imaging sensor.

In a further step 120, at least one region of interest is marked in the thermal image. The marking can take place, for example, in a first display of the thermal image. However, an additional VIS camera can also be provided to record an image in the visible spectrum, in which the region of interest can be selected and marked. For this purpose, the image region of the VIS camera preferably corresponds to the image region of the thermal imaging camera.

The region of interest can also be automatically defined in the image center and have a predetermined size. Many further options are conceivable here, which have no influence on the invention, however.

In a further step 130, an imaging function is defined, according to which the colors are assigned to a temperature range, wherein contrasts are amplified in the region of interest and contrasts are reduced outside the region of interest.

In a last step 140, the imaging function is applied to the thermal image. This means that the colors are assigned to the temperature values according to the imaging function. A display of the thermal image results due to this assignment, which can be stored or displayed on a display screen, for example.

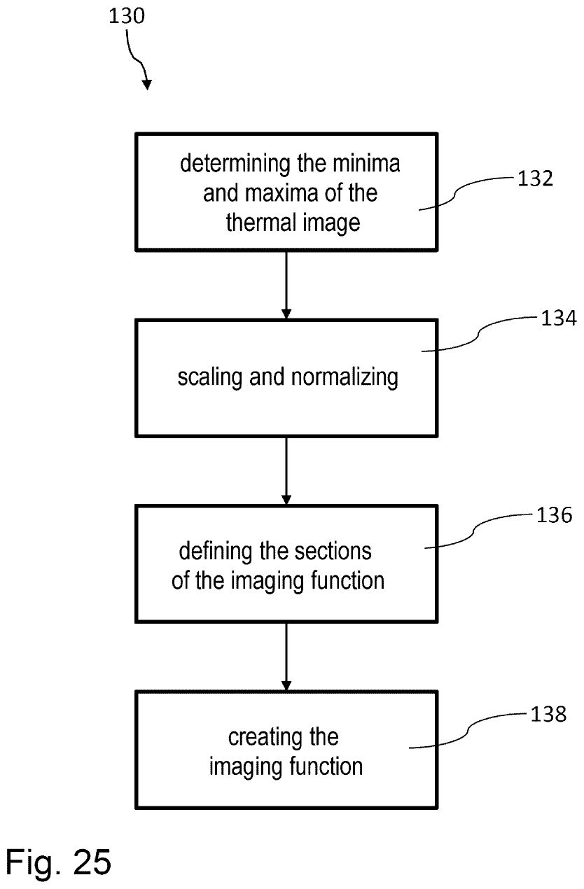

FIG. 25 shows a flow chart of a first method for defining the imaging function 160 as a sectionally linear imaging function.

In a first step 162, initially the global and regional minima and maxima of the temperature values in the thermal image are defined. These are designated hereinafter by Gmin, Gmax, Rmin, and Rmax.

In a second step 164, the number of colors is scaled to the temperature range occurring in the thermal image and the regional minimum and maximum are normalized according to the following rule.

$$\# normalize Rmin , Rmax$$

$$resolution = 4096$$

$$s = resolution / ( Gmax - Gmin ) \# scale factor$$

$$Rmin 2 = ( Rmin - Gmin ) * s$$

$$Rmax 2 = ( Rmax - Gmin ) * s$$

Rmin2 and Rmax2 are the color values between 0 and 4095, in which the temperature limits Rmin and Rmax lie.

In a following step 166, a sectionally linear imaging function is defined. The regional extremes, thus Rmin and Rmax each form a section change here. The imaging function accordingly contains 3 sections as a rule.

A first section 8 for the temperature range Rmin2<T_1<Rmax2.

An upper section 10 for the temperature range T_1>Rmax2 and a lower section 9 for the temperature range T_1<Rmin2.

In each section, a linear imaging is selected so that in the first section 8, 90% of the available colors are used. In each of the two other sections 9, 10, 5% of the colors are used.

In this way, the majority of the colors are used for the temperature values which occur in the region of interest 2, so that the display takes place there with substantially more detail and with higher contrast.

The sectionally linear imaging function 7, for example that of FIG. 5, is therefore a reassignment of the color values and still not a direct assignment of the colors to temperature values.

In FIG. 5, for example, in the lower section 9, the colors having the values 0 to Rmin2 (approximately 1414) are reassigned to the color values between 0 and 204, while the values of the region of interest between Rmin2 and Rmax2 are now assigned 3800 color values instead of approximately 600 color values.

$$p 1 = ( Rmin 2 , 0.05 * resolution )$$

$$p 2 = ( Rmax 2 , 0.9 * resolution )$$

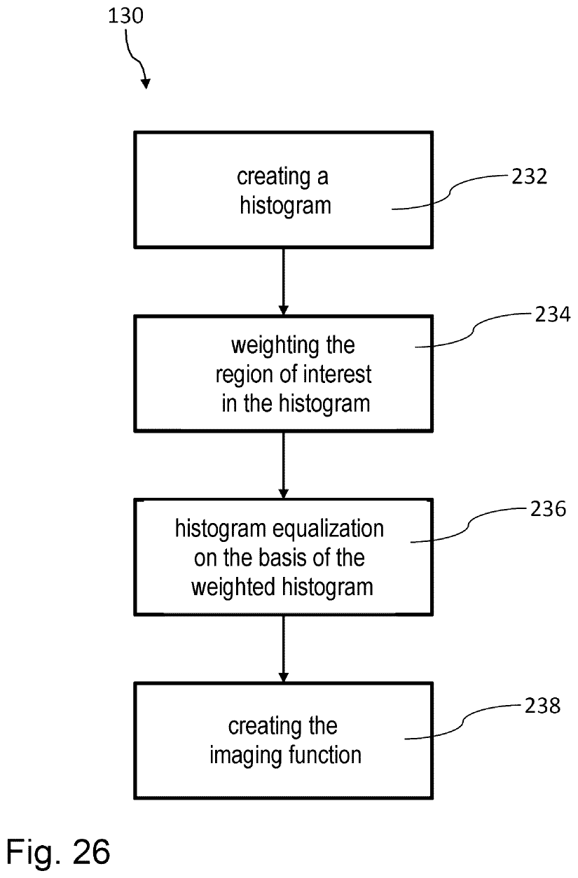

FIG. 26 shows a flow chart of a further method 162 for defining the imaging function according to an adapted histogram equalization.

The imaging function is selected here according to a histogram equalization, wherein the temperature values within the first section 8 are weighted more strongly than temperature values which only occur in further sections 9, 10.

In a first step 262, a histogram of a thermal image is created. Such a histogram is shown, for example, in FIGS. 3 and 14.

In a second step 264, the region of the histogram which lies within the region of interest 2 is weighted using a weighting factor. For this purpose, all values within the region of interest are multiplied by this weighting factor. In the example, this weighting factor is selected as 10. However, other factors can also be selected. A histogram adapted to the region of interest results therefrom, as shown in FIGS. 8 and 19.

In a further step 266, a histogram equalization is carried out, starting from the adapted histogram.

Finally, in step 268, an imaging function is created on the basis of the adapted histogram equalization.

### LIST OF REFERENCE NUMERALS

1 thermal image
2 region of interest
3 main peak
4 second peak
5 flat area
6 linear imaging function
7 sectionally linear imaging function
8 first section
9 lower section
10 upper section

1. A method for displaying a thermal image, the method comprising:
assigning one color of a color palette in each case to a temperature range of the thermal image depending on whether certain criteria of a temperature distribution occur in a geometric region of the thermal image.

2. The method as claimed in claim 1, further comprising assigning more colors of the color palette to the temperature range which occurs within a region of interest in the thermal image than would be the case with uniform color distribution.

3. The method as claimed in claim 1, further comprising assigning a larger range of the color palette to the temperature range more frequently and geometrically closer to where a region of interest of thermal image temperature values within the temperature range occur.

4. The method as claimed in claim 3, wherein a number of the colors is assigned to the temperature range depending on how much more frequently and how much geometrically closer to the region of interest of the thermal image temperature values occur within the temperature range.

5. The method as claimed in claim 1, further comprising assigning the temperature ranges having specific gradients within a region of interest a larger range of the color palette.

6. The method as claimed in claim 1, further comprising marking at least one region of interest (2) in the thermal image (1), defining an imaging function (7), according to which the colors are assigned to a temperature range, and amplifying contrasts in the at least one region of interest and reducing contrasts outside of the at least one region of interest.

7. The method as claimed in claim 6, further comprising dividing the imaging function into a first section and further sections (8, 9, 10), wherein the first section (8) is given by temperature limits of the at least one region of interest (2), and the further sections (9, 10) image the temperatures outside the at least one region of interest, and selecting the imaging function (7) in the first section (8) so that contrasts are increased, and selecting the imaging function (7) in the further sections so that contrasts are reduced.

8. The method as claimed in claim 7, wherein the imaging function (7) assigns more colors to the first section (8) than the further sections (9, 10) to increase the contrast.

9. The method as claimed in claim 7, further comprising selecting the imaging function according to a histogram equalization, wherein the temperature values within the first section (8) are weighted more strongly than the temperature values which only occur in the further sections (9, 10).

10. The method as claimed in claim 9, further comprising, in creating the histogram, multiplying a temperature value which occurs within the region of interest by a weighting factor, so that the temperature value is taken into consideration disproportionately in the histogram.

11. The method as claimed in claim 6, wherein the region of interest (2) is marked by selecting a pixel or image detail.

12. The method as claimed in claim 6, wherein the region of interest comprises multiple pixels of the thermal image.

13. The method as claimed in claim 6, wherein the region of interest (2) is marked in an automated manner in an image center of the thermal image or at a point having a highest or lowest temperature.

14. The method as claimed in claim 6, wherein a size of the region of interest (2) is defined, settable, and/or changeable.

15. The method as claimed in claim 6, wherein the region of interest (2) is defined by a circle, a rectangle, a square, or another geometry.

16. The method as claimed in claim 6, further comprising providing an image in a visible spectral range, image detail of which substantially corresponds to the image detail of the thermal image, marking the region of interest (2) in the visible image, and transferring the region of interest (2) to the thermal image.

17. The method as claimed in claim 16, further comprising marking multiple ones of the regions of interest, and viewing the multiple ones of the regions of interest as a contiguous region of interest.
